(19) United States
(12) Patent Application Publication
(10) Pub. No.: US 2025/0074296 A1
(43) Pub. Date: Mar. 6, 2025

(54) TRAILER LIGHT DETECTION SYSTEMS AND METHODS

(71) Applicant: Ford Global Technologies, LLC, Dearborn, MI (US)

(72) Inventors: Sheran Anthony Alles, Livonia, MI (US); Manuel Leon, Ecatepec (MX); Sandeep Pothuganti, Novi, MI (US)

(73) Assignee: Ford Global Technologies, LLC, Dearborn, MI (US)

(21) Appl. No.: 18/456,756

(22) Filed: Aug. 28, 2023

(51) Int. Cl. B60Q 1/50; B60Q 1/00

(52) U.S. Cl. CPC B60Q 1/50; B60Q 1/0094

(57) ABSTRACT

A trailer light management system is disclosed. The system may include a constant current source circuit and a processor. The constant current source circuit may be configured to supply a current to a trailer light. The processor may be configured to obtain a trigger signal and cause the constant current source circuit to supply the current to the trailer light responsive to obtaining the trigger signal. The processor may be further configured to determine a voltage drop in the constant current source circuit responsive to supplying the current. In addition, the processor may determine that a predefined condition may be met based on the voltage drop. The processor may perform a predefined action responsive to determining that the predefined condition may be met.

### TECHNICAL FIELD

The present disclosure relates to trailer light detection systems and methods and more particularly to systems and methods for detecting trailer lights in an OFF state.

### BACKGROUND

Trailers are typically attached to towing vehicles that drive the trailers. Trailers have cargo space in which users may store goods to be transported, and the towing vehicles include engines (e.g., internal combustion engines (ICE), electric vehicles (EV), and/or hybrids) that may provide power to drive the trailers. Trailers can also be in the form of recreation vehicles (RVs) that may not necessarily be used to transport cargo, but may be used for recreational activities.

Most modern trailers are both mechanically and electrically coupled with the towing vehicles. Electric coupling enables the trailer lights (e.g., stop lights, tail lights, turn lights, etc.) to operate in a similar manner as the corresponding lights in the towing vehicle. For example, if the stop lights of the towing vehicle are illuminated, electric coupling between the trailer and the towing vehicle may enable the stop lights of the trailer to also illuminate at the same time and in the same manner as the towing vehicle's stop lights.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of a trailer light management system in accordance with the present disclosure.

FIG. 3 depicts a circuit diagram of a portion of the trailer light management system of FIG. 2 in accordance with the present disclosure.

FIG. 4 depicts a flow diagram of a trailer light management method in accordance with the present disclosure.

### DETAILED DESCRIPTION

### Overview

The present disclosure describes a trailer light management system configured to facilitate detection of electrical connection status between a vehicle and a trailer. Specifically, the system may be configured to detect electrical connection status between system circuitry and trailer lights, thereby enabling detection of connection status between the vehicle and the trailer. The system may be part of the vehicle and may perform OFF-state diagnostics of trailer lights to ascertain the connection status.

In some aspects, the system may include a constant current source that may be configured to supply a pulse of low constant current to the trailer lights, when the trailer lights may be in OFF-state. The constant current source may supply the pulse of low constant current such that the trailer lights may not illuminate, when the trailer lights receive the low constant current. Responsive to supplying the low constant current, the system may measure a voltage drop across the circuitry associated with the constant current source. Specifically, the system may measure a voltage at an output of the constant current source, and compare it with a supply voltage provided to the constant current source (to measure the voltage drop). When the measured voltage approaches (or is equivalent to) the supply voltage of the constant current source, the system may determine that the trailer may not be present or connected with the vehicle or the circuit may be open. Responsive to such determination, the system may transmit a notification to a vehicle Human-Machine Interface (HMI) and/or a user device/a vehicle alarm, indicating to a vehicle operator that the trailer may not be present or may have been disconnected from the vehicle.

On the other hand, when the measured voltage at the output of the constant current source may be less than the supply voltage, the system may determine that the trailer lights may be electrically coupled with the constant current source, thereby indicating that the trailer may be optimally coupled with the vehicle. The system may additionally determine trailer light type based on the voltage drop measured across the constant current source circuit (i.e., the difference between the supply voltage and the voltage at the output of the constant current source). If the trailer light is a series/parallel LED string, the forward voltage may indicate the number/count of the LEDs present. If the trailer light assembly has a parallel resistor, depending on the size of the resistor, the voltage drop measured will be small and indistinguishable from a short to ground condition. Such a condition may also be similar to a trailer light that may include an incandescent bulb. In such a case, the trailer light may be turned ON prior to performing the operation described above, and a current measurement may be performed to establish or confirm that a short to ground is not present.

Some trailer light assemblies may have active circuitry, including front end capacitors. Depending on the size of these capacitors, the constant current source may provide a voltage that may approach a ramp. This may also be measured via an analog-to-digital input. In certain scenarios, if the input capacitance is large (e.g., larger than a predefined capacitance value), the low constant current source would be insufficient to charge the capacitor within the ON duration of the low constant current source, and may also be indistinguishable from a short to ground.

A similar identification may be used to distinguish any corrosion to ground on a trailer connector, without a trailer being connected. This method eliminates false connectivity detection.

In further aspects, the system may include a driver unit configured to supply a high current (greater than the low constant current) to the trailer lights. The trailer lights may illuminate responsive to receiving the high current. Responsive to determining that the measured voltage at the output of the constant current source may be less than the supply voltage, the system may cause the driver unit to supply a pulse of high current to the trailer lights. The system may then measure current/voltage across the driver unit to confirm/ascertain that the electrical connection status between the trailer and the vehicle, as determined by measuring the voltage drop across the constant current source, is correct and accurate. Responsive to confirming the electrical connection status, the system may transmit a notification to the vehicle HMI and/or the user device, indicating to the vehicle operator that the trailer may be optimally connected with the vehicle.

In some aspects, the system may continue to perform trailer light OFF-state diagnostics at a predefined frequency (e.g., every 1 second) by using the constant current source, till the trailer lights continue to be in OFF-state.

The present disclosure discloses a system to “detect” trailer lights in OFF-sate or determine electrical connection status between the trailer lights and the system, thereby detecting connection status between the trailer and the vehicle. The system provides timely notifications to the vehicle operator when the system determines that the trailer may not be optimally coupled with the vehicle. Further, since the system performs the trailer light OFF-state diagnostics by supplying a pulse of low constant current, the trailer lights do not illuminate during the diagnostics, thus ensuring that the vehicle operator and/or users in proximity to the vehicle/trailer are not disturbed. Further, the supply of low constant current ensures that the vehicle battery is not considerably drained during the OFF-state diagnostic operation.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

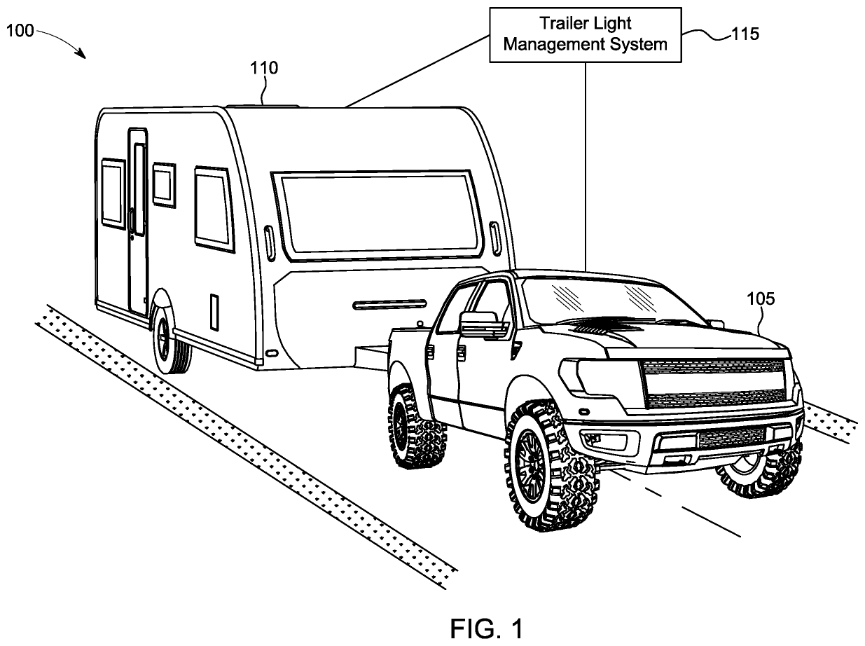

FIG. 1 depicts an example environment 100 in which techniques and structures for providing the systems and methods disclosed herein may be implemented. The environment 100 may include a towing vehicle 105 (or a vehicle 105) attached to a trailer 110. The trailer 110 may be attached to a vehicle rear portion, as shown in FIG. 1. In particular, the trailer 110 may be attached to the vehicle rear portion by using mechanical and/or magnetic fasteners and via electrical coupling.

The vehicle 105 may take the form of any passenger or commercial vehicle such as, for example, a car, an off-road vehicle, a work vehicle, a crossover vehicle, a van, a minivan, a taxi, a bus, a truck, etc. Further, the vehicle 105 may be a manually driven vehicle and/or may be configured to operate in partially or fully autonomous mode and may include any powertrain such as, for example, a gasoline engine, one or more electrically-actuated motor(s), a hybrid system, etc.

The trailer 110 may be a cargo trailer that may be used to transport goods, or may be a Recreational Vehicle (RV). In some aspects, the trailer 110 may be electrically coupled (e.g., via a wire harness, not shown) with the vehicle 105 such that one or more trailer electric components may mimic operation of corresponding one or more vehicle electric components. For example, trailer lights (such as trailer stop lights, tail lights, turn lights, reverse lights, fog lights, parking lights, etc.) may mimic operation of corresponding vehicle lights. In an exemplary aspect, when a vehicle operator (not shown) activates a vehicle's light, e.g., a fog light, the corresponding trailer fog light may also get activated/illuminated.

A person ordinarily skilled in the art may appreciate that such electrical coupling between the trailer 110 and the vehicle 105 facilitates efficient vehicle operation, especially when the vehicle 105 is being driven. For example, when the vehicle operator desires to a take a turn (e.g., a left or right turn), the vehicle operator may activate the vehicle turn lights. Responsive to the vehicle turn lights being activated, the trailer turn lights may also get activated, thereby providing an indication to a vehicle trailing the trailer 110 that the vehicle 105/trailer 110 is about to take a turn. This may facilitate the vehicle operator who may be driving the vehicle trailing the trailer 110 that the vehicle 105/trailer 110 to maneuver the trailer vehicle efficiently, especially if the vehicle operator is not able to view the vehicle turn lights.

There may be instances where the electrical coupling between the trailer 110 and the vehicle 105 may get interrupted or broken. For example, there may be instances where the trailer 110 may not be properly connected (e.g., electrically connected) with the vehicle 105 via the wire harness, resulting in broken vehicle and trailer electrical connection. As another example, the electrical connection may get broken when the vehicle 105 and trailer 110 may travelling on a bumpy road. It may be important for the vehicle operator to know of such a broken or interrupted electrical connection in a timely manner, when the vehicle operator may be about to begin a trip or when the vehicle 105 may be driven on the trip.

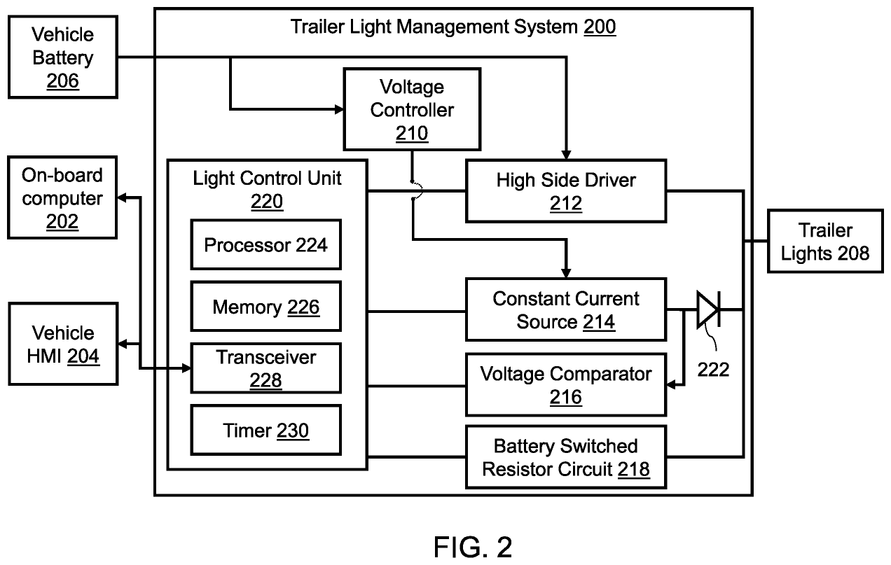

In some aspects, the environment 100 may further include a trailer light management system 115 (or system 115) that may be communicatively and electrically connected with the vehicle 105 and the trailer 110. The system 115 may be configured to control operation of trailer lights (shown as trailer lights 208 in FIG. 2) and detect electrical connection status between the vehicle 105 and the trailer 110. In some aspects, the system 115 may be part of the vehicle 105 and may be configured to supply current to the trailer lights. In other aspects, the system 115 may be a separate module electrically (and communicatively) connected with the vehicle 105 and the trailer 110.

The system 115 may be configured to detect electrical connection between the vehicle 105 and the trailer 110 by determining status of electrical connection between the vehicle 105 and the trailer lights. When the electrical connection between the vehicle 105 and the trailer lights may be active or uninterrupted, the system 115 may determine that the vehicle 105 may be optimally connected with the trailer 110 via the wire harness. On the other hand, when the electrical connection between the vehicle 105 and the trailer lights may interrupted or broken, the system 115 may determine that the vehicle 105 may not be optimally connected with the trailer 110 via the wire harness.

In some aspects, the system 115 may be configured to perform OFF-state diagnostics of the trailer lights to determine the electrical connection status between the vehicle 105 and the trailer lights. The OFF-state diagnostics, as described here in the present disclosure, means detection of electrical connection status between the vehicle 105 and the trailer lights when the trailer lights may be in an OFF state (or when vehicle ignition may be switched OFF). In some aspects, the system 115 may perform trailer light OFF-state diagnostics such that the trailer lights may not flicker (or illuminate) when the system 115 performs the OFF-state diagnostics, thereby ensuring that the vehicle operator or users in proximity to the vehicle 105/trailer 110 are not disturbed.

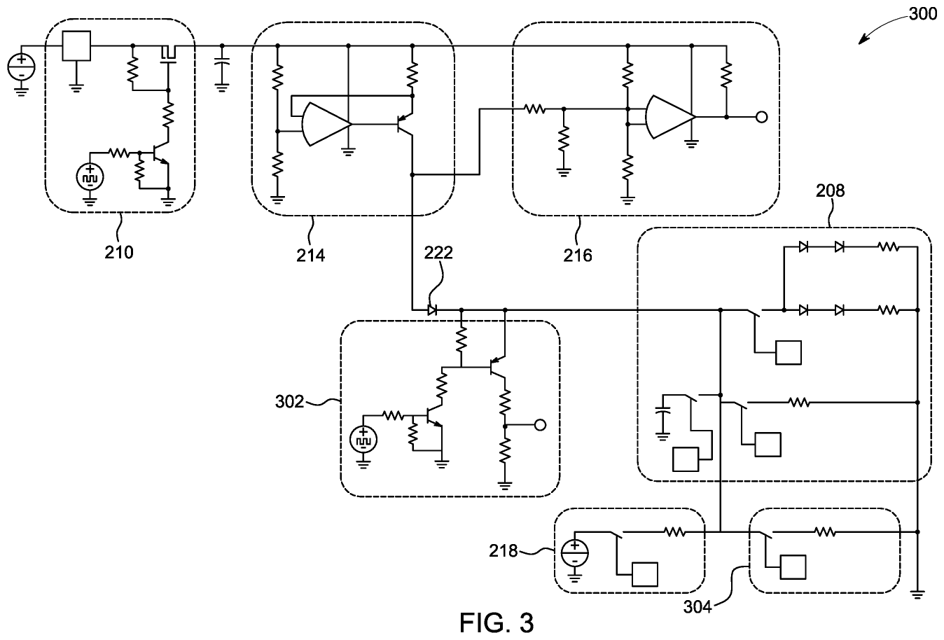

The system 115 may include a constant current source (shown as constant current source 214 in FIG. 2) that may be configured to supply a low constant current (e.g., less than or equivalent to 2 microamperes (μA)) to the trailer lights at a predefined frequency, when the system 115 performs the trailer light OFF-state diagnostics. Responsive to the constant current source supplying the low constant current, the system 115 may measure a voltage at an output of the constant current source circuit. The system 115 may determine that the trailer lights (and hence the trailer 110) may be electrically connected with the vehicle 105 when the measured voltage may be less than a voltage supplied to the constant current source (or “supply voltage”). On the other hand, the system 115 may determine that the trailer lights may not be electrically connected with the vehicle 105 (or the circuit may be shorted) when the measured voltage at the output of the constant current circuit may be equivalent or close to the supply voltage of the constant current source. In this case, the system 115 may output a notification to a vehicle Human-Machine Interface (HMI) or a user device (e.g., via a wireless network) indicating that the electrical connection between the vehicle 105 and the trailer 110 may be interrupted or broken. Responsive to obtaining the notification on the vehicle HMI or the user device, the vehicle operator may take remedial actions. In this manner, the system 115 facilitates in timely detection of interrupted or broken electrical connection between the vehicle 105 and the trailer 110. Further details of the system 115 are described below in conjunction with FIGS. 2 and 3.

The vehicle 105, the vehicle operator, and the system 115 implement and/or perform operations, as described here in the present disclosure, in accordance with the owner manual and safety guidelines. In addition, any action taken by the vehicle operator should comply with all rules and regulations specific to the location and operation of the vehicle 105 (e.g., Federal, state, country, city, etc.). The notifications, as provided by the vehicle 105 or the system 115, should be treated as suggestions and only followed when safe to do so and when in compliance with any rules and regulations specification to the location and operation of the vehicle 105.

FIG. 2 depicts a block diagram of an example trailer light management system 200 (or system 200) in accordance with the present disclosure. The system 200 may be same as the system 115 described above. While describing FIG. 2, references will be made to FIG. 3, which depicts an example circuit diagram 300 of a portion of the system 200 and trailer lights associated with the trailer 110.

The system 200 may be communicatively coupled with a vehicle on-board computer 202 (or on-board computer 202) and a vehicle Human-Machine Interface (HMI) 204 via one or more network(s). The on-board computer 202 may be associated with the vehicle 105 and may be configured to transmit instructions and/or commands signals to the system 200. Further, the system 200 may be configured to transmit notifications and/or signals to the on-board computer 202. The system 200 may be additionally configured to transmit notifications to the vehicle HMI 204 to enable the vehicle operator to conveniently view/hear visual and/or audible notifications. The system 200 may further be communicatively coupled with a user device (e.g., a user device associated with the vehicle operator, not shown) and may be configured to transmit/receive signals/notifications/inputs to or from the user device via the network(s). The user device may be, for example, a mobile phone, a laptop, a computer, a tablet, or any other similar device with communication capabilities.

The network(s), as described above, illustrates an example communication infrastructure in which the connected devices discussed in various embodiments of this disclosure may communicate. The network(s) may be and/or include a controller area network (CAN) or similar automotive protocols, the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, the system 200 may be electrically coupled with a vehicle battery 206 (or vehicle batteries) and trailer lights 208, which may be the trailer lights associated with the trailer 110. The system 200 may be configured to obtain power from the vehicle battery 206. In some aspects, the system 200 may include the vehicle battery 206. In other aspects, the vehicle battery 206 may be outside of the system 200 (as shown in FIG. 2). In further aspects, the system 200 may be connected to one or more trailer batteries (not shown) or may include its own system batteries (not shown) that may provide power to one or more system units. Furthermore, the system 200 may be configured to supply current to the trailer lights 208 (responsive to obtaining power from the batteries described above) and perform OFF-state diagnostics of the trailer lights 208, as described in detail later below.

The system 200 may include one or more units or circuitries including, but not limited to, a voltage controller 210, a high side driver circuit 212 (or high side driver 212), a constant current source circuit 214 (or constant current source 214), a voltage sensor or comparator 216 (or directly buffered to an analog-to-digital interface of a Light Control Unit 220 of the system 200), a battery switched resistor circuit 218 and the light control unit 220, which may be electrically and/or communicatively coupled with each other.

The voltage controller 210 may be electrically connected with the vehicle battery 206 or one or more additional batteries (or energy sources) described above and may be configured to obtain power from the vehicle battery 206 (or additional batteries/energy sources). The voltage controller 210 may be further configured to provide a controlled voltage (or a “supply voltage”) at a predefined voltage level to the constant current source 214. The predefined voltage level may be, for example, in a range of 8 to 10 Volts (V). In a preferred aspect, the predefined voltage level may be 9V. In some aspects, the voltage controller 210 may be configured to provide the controlled voltage to the constant current source 214 when the voltage controller 210 obtains a command signal from the on-board computer 202 and/or the light control unit 220. An example electric circuitry of the voltage controller 210 is shown in the circuit diagram 300. The electric circuitry depicted in the circuit diagram 300 is for illustrative purpose only and should not be construed as limiting the present disclosure scope.

The constant current source 214 may be configured to supply a low constant current (e.g., a “first current”) to the trailer lights 208 via a diode 222, responsive to obtaining the controlled voltage (or the supply voltage) from the voltage controller 210. The diode 222 may be part of the system 200 and may be included in the system circuit to prevent reverse current from the trailer lights 208 (e.g., to the constant current source 214). The diode may act as an isolation between the constant current source 214 and higher switched voltage or current. In some aspects, the constant current source 214 may supply the first current to the trailer lights 208 when the system 200 performs the trailer light OFF-state diagnostics, as described in detail later below. An example electric circuitry of the constant current source 214 is shown in the circuit diagram 300.

In some aspects, the constant current source 214 may supply the first current to the trailer lights 208 as a pulse of constant current for a predefined time duration. The predefined time duration may be, for example, in a range of 2 to 4 milliseconds (ms). In a preferred aspect, the predefined time duration may be 2 ms. Further, the first current may be less than a predefined current threshold. The predefined current threshold may be based on the types of trailer lights 208 included in the trailer 110, such that the trailer lights 208 may not illuminate responsive to receiving the first current. In an exemplary aspect, the predefined current threshold may be equivalent to or less than 2 μA, when the trailer lights 208 include Light Emitting Diodes (LEDs). In some aspects, the constant current source 214 may be switchable between different current levels (e.g., 2 μA, 10 μA, etc.) based on trailer light types and user inputs and/or command signals obtained from the on-board computer 202, the vehicle HMI 204, and/or the user device.

The voltage sensor or comparator 216 may be configured to determine a voltage drop in the circuitry associated with the constant current source 214 when the constant current source 214 supplies the first current. The voltage drop may be a difference between the supply voltage and a voltage at an output of the constant current source 214. The voltage sensor or comparator 216 may be configured to compare a voltage at an input of the constant current source 214 (i.e., the supply voltage) with a voltage at the output of the constant current source 214, to determine the voltage drop across the constant current source 214 responsive to the constant current source 214 supplying the first current. An example electric circuitry of the voltage comparator 216 is shown in the circuit diagram 300. In some aspects, the system 200 may further include an analog-to-digital convertor (ADC) voltage monitor 302 (shown in FIG. 3) that may be configured to detect/sense voltage at the output of the constant current source 214. The ADC voltage monitor 302 may enable the system 200 to determine if there may be a short circuit at the output of the constant current source 214 or in the circuitry between the constant current source 214 and the trailer lights 208. Example electric circuitries of one or more trailer lights 208 are shown in the circuit diagram 300.

In some aspects, the high side driver 212 may be a metal-oxide-semiconductor field-effect transistor (MOSFET) driver. The high side driver 212 may be configured to directly obtain power from the vehicle battery 206. Stated another way, the vehicle battery 206 may be configured to power the high side driver 212. The high side driver 212 may be configured to supply a second current to the trailer lights 208, responsive to receiving command signals from the on-board computer 202 and/or the light control unit 220. The second current may be greater than the first current and may be configured to illuminate the trailer lights 208. Stated another way, the trailer lights 208 may illuminate responsive to receiving the second current. In an exemplary aspect, the second current may be equivalent to or greater than 30 mA.

In some aspects, when the vehicle operator or the vehicle 105 activates one or more vehicle lights (e.g., vehicle turn lights), the on-board computer 202 may send a command signal to the high side driver 212 (directly or via the light control unit 220) to activate the corresponding trailer turn lights (when the vehicle 105 and the trailer 110 may be electrically coupled with each other). Responsive to receiving the command signal, the high side driver 212 may supply the second current to the corresponding trailer turn lights, to activate or illuminate the trailer turn lights. In this manner, the system 200 ensures that the trailer turn lights mimic the vehicle turn lights, when the vehicle 105 and the trailer 110 may be electrically coupled with each other. In further aspects, the system 200 may use the high side driver 212 when the system 200 performs the trailer light OFF-state diagnostics, as described later in the description below.

The light control unit 220 may include one or more units including, but not limited to, a processor 224, a memory 226, a transceiver 228 and a timer 230. The units included in the light control unit 220 may be communicatively coupled with each other and other components of the systems 200, the on-board computer 202, and the vehicle HMI 204. The transceiver 228 may be configured to transmit/receive signals/data/notifications, etc. to/from one or more system components, the on-board computer 202 and the vehicle HMI 204.

The processor 224 may be disposed in communication with one or more memory devices (e.g., the memory 226 and/or one or more external databases not shown in FIG. 2). The processor 224 may utilize the memory 226 to store programs in code and/or to store data for performing various system operations in accordance with the present disclosure. The memory 226 may be a non-transitory computer-readable storage medium or memory storing computer-executable instructions which when executed by the processor 224 enables the processor 224 to perform various system operations. The memory 226 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.

The timer 230 may be configured to generate one or more trigger signals at a predefined frequency (e.g., every 1 second or 2 seconds) when the system 200 may be performing the trailer light OFF-state diagnostics and transmit the trigger signal(s) to the processor 224. The usage of trigger signals may be understood in conjunction with the description provided below.

In operation, the processor 224 may obtain a first trigger signal from the on-board computer 202, via the transceiver 228. The first trigger signal may indicate/signal to the processor 224 to commence the trailer light OFF-state diagnostics to check whether the vehicle 105 may be electrically coupled with the trailer 110. In some aspects, the processor 224 may obtain the first trigger signal from the on-board computer 202 when the trailer lights 208 may be switched OFF (and/or when the vehicle ignition may be switched OFF). As an example, when the vehicle operator mechanically (and electrically) connects the trailer 110 with the vehicle 105 (but may not activate the vehicle lights and hence the trailer lights 208), the on-board computer 202 may generate and send the first trigger signal to the processor 224 to commence the trailer light OFF-state diagnostics and ascertain whether the vehicle operator has properly connected the vehicle 105 with the trailer 110.

Responsive to obtaining the first trigger signal, the processor 224 may send a command signal to the voltage controller 210 to supply the controlled voltage (e.g., the supply voltage of 9V) to the constant current source 214. When the constant current source 214 obtains the controlled voltage from the voltage controller 210, the constant current source 214 may supply the first current to the trailer lights 208 as a pulse of constant current for a predefined time duration (e.g., 2 ms). Stated another way, responsive to obtaining the first trigger signal, the processor 224 may cause the constant current source 214 to supply the first current to the trailer lights 208.

In some aspects, since the trailer light OFF-state diagnostics may be performed when the vehicle ignition may be switched OFF, the first current may be kept at a low constant value (e.g., equivalent to or less than 2 μA) to ensure that the vehicle battery 206 (or any other system or trailer energy source) is not drained. The first current may also be kept at a low constant value to ensure that the trailer lights 208 do not illuminate, as described above.

Responsive to supplying the first current to the trailer lights 208, the processor 224 may determine a voltage drop across the circuitry associated with the constant current source 214. As described above, the voltage drop may be a difference between the supply voltage and a voltage at the output of the constant current source 214. In some aspects, the processor 224 may obtain inputs from the voltage sensor or comparator 216 to determine the voltage drop in the constant current source 214 based on the obtained inputs. In additional or alternative aspects, the processor 224 may determine the voltage drop or the voltage measured at the output of the constant current source 214 based on inputs/readings obtained from the ADC voltage monitor 302.

The processor 224 may be configured to determine trailer light connection status with the constant current source 214 (and hence status of electrical connection between the vehicle 105 and the trailer 110) based on the determined voltage drop. Specifically, responsive to determining the voltage drop, the processor 224 may determine whether a predefined condition may be met based on the voltage drop. In some aspects, the predefined condition may be met when the voltage measured at the output of the constant current source 214 may be equivalent to or close to the supply voltage. Responsive to determining that the predefined condition may met, the processor 224 may perform a predefined action.

Specifically, responsive to determining that the voltage measured at the output of the constant current source 214 may be equivalent to or close to the supply voltage, in some aspects, the processor 224 may first determine whether there may be a short circuit in the circuitry connecting the constant current source 214 and the trailer lights 208, based on the inputs/readings obtained from the ADC voltage monitor 302. When there may be short circuit, the processor 224 may transmit/output a notification to the vehicle HMI 204 and/or the user device, via the transceiver 228, indicating to the vehicle operator that there may be a short circuit. The vehicle operator may then take remedial actions to get the short circuit fixed.

On the other hand, responsive to determining that there may not a short circuit, the processor 224 may determine that the trailer lights 208 may not be electrically coupled with the constant current source 214 when the voltage measured at the output of the constant current source 214 may be equivalent to or close to the supply voltage. In this case, the processor 224 may transmit/output a notification to the vehicle HMI 204 and/or the user device, via the transceiver 228, indicating to the vehicle operator that the trailer lights 208 may not be electrically coupled with the constant current source 214, or the trailer 110 may not be properly connected with the vehicle 105. Responsive to viewing/hearing the notification, the vehicle operator may properly connect the trailer 110 with the vehicle 105. In this manner, the system 200 enables the vehicle operator to get a timely notification when the trailer 110 may not be properly connected with the vehicle 105.

In further aspects, the predefined condition may be met when the voltage measured at the output of the constant current source 214 may be less than the supply voltage. Responsive to determining that the voltage measured at the output of the constant current source 214 may be less than the supply voltage, the processor 224 may determine that the trailer lights 208 may be electrically connected with the constant current source 214, and hence the trailer 110 may be properly connected with the vehicle 105.

The processor 224 may be further configured to determine a trailer light type based on the voltage drop across the constant current source 214 (i.e., the difference between the supply voltage and the voltage measured at the output of the constant current source 214), when the voltage measured at the output of the constant current source 214 may be less than the supply voltage. In some aspects, the trailer lights 208 may include one or more different types of trailer lights, e.g., lights with LEDs, incandescent lamps, lights with capacitive loads, etc., and the processor 224 may determine the trailer light type based on the voltage drop. In some aspects, the voltage drop may be proportional to the forward voltage of the LEDs when the trailer lights 208 include LEDs. Further, the voltage drop may be low when the trailer lights 208 include incandescent lamps and may ramp during capacitor charging when the trailer lights 208 include capacitive loads. The processor 224 may check the voltage drop profile to determine the trailer light type.

In further aspects, when the processor 224 determines that the trailer 110 may be properly connected with the vehicle 105 and the trailer light type based on the voltage drop across the constant current source 214, the processor 224 may perform additional diagnostics to confirm the vehicle-trailer electrical connection status and the determined trailer type. The processor 224 may perform the additional diagnostics to gain confidence of the findings identified by measuring the voltage drop across the constant current source 214.

In some aspects, to perform the additional diagnostics and responsive to determining that the voltage measured at the output of the constant current source 214 may be less than the supply voltage, the processor 224 may transmit a command signal to the high side driver 212 to supply a pulse of the second current to the trailer lights 208. Stated another way, responsive to determining that the voltage measured at the output of the constant current source 214 may be less than the supply voltage, the processor 224 may cause the high side driver 212 to supply the second current to the trailer lights 208 for a predefined short time duration. In some aspects, the processor 224 may cause the high side driver 212 to supply the second current to the trailer lights 208 by transmitting, via the transceiver 228, a notification to the vehicle HMI 204 requesting the vehicle operator to activate a vehicle light (e.g., press vehicle brake to activate vehicle brake lights). When the vehicle operator activates the vehicle brake lights, a command signal may be transmitted by the on-board computer 202 to the high side driver 212 (via the processor 224) to cause the high side driver 212 to supply the second current to the trailer lights 208. In other aspects, the processor 224 may itself send the command signal to the high side driver 212 to supply the second current to the trailer lights 208, without requesting the vehicle operator to press vehicle brakes. In some aspects, the processor 224 may cause the high side driver 212 to supply the second current to the trailer lights 208 once (or twice). This may all be done when the vehicle is stationary.

Responsive to receiving the second current, the trailer lights 208 may flash or illuminate once (since the second current may be supplied to the trailer lights 208 once, as described above), when the trailer lights 208 may be electrically coupled with the high side driver 212 or when the trailer 110 may be electrically coupled with the vehicle 105. When the trailer lights 208 flash, the processor 224 may measure current/voltage across the high side driver 212 to ascertain connection of the trailer 110 with the vehicle 105. Specifically, since the second current may be considerably greater than the first current, the readings/findings determined based on measuring the current/voltage across the high side driver 212 may be more accurate. When the measured current/voltage across the high side driver 212 indicates an electrical connection between the trailer 110 (or the trailer lights 208) and the vehicle 105 (or the high side driver 212), the processor 224 may determine with confidence that the trailer 110 may be optimally connected with the vehicle 105. In some aspects, the processor 224 may further determine with confidence the trailer light type based on the measured current/voltage across the high side driver 212, or based on the second current provided by the high side driver 212 to the trailer lights 208.

Responsive to determining (with confidence) that the trailer 110 may be optimally connected with the vehicle 105 and the trailer light type, the processor 224 may transmit, via the transceiver 228, a notification to the vehicle HMI 204 and/or the user device, indicating that the electrical connection may be successful (and the corresponding trailer light type for vehicle operator's reference).

Furthermore, when the detection or determination of the electrical connection between the trailer 110 and the vehicle 105, as identified by measuring the voltage at the output of the constant current source 214, corroborates with the determination/findings identified by using the high side driver 212 as described above, the processor 224 may determine that the constant current source 214 may be used to accurately perform the trailer light OFF-state diagnostics. Responsive to such determination, the processor 224 may perform the trailer light OFF-state diagnostics at a predefined frequency (e.g., every 1 second) by using the constant current source 214, till the vehicle operator activates the vehicle lights, thereby activating the trailer lights 208.

When the processor 224 performs the trailer light OFF-state diagnostics at the predefined frequency, the processor 224 may obtain trigger signals (e.g., second trigger signals) from the timer 230 at the predefined frequency. Responsive to obtaining a second trigger signal, the processor 224 may cause the constant current source 214 to supply the first current to the trailer lights 208, as described above. Further, the processor 224 may determine the voltage drop across the constant current source 214 to ascertain the electrical connection status between the trailer 110 and the vehicle 105, as described above. The processor 224 may continue to perform the trailer light OFF-state diagnostics at the predefined frequency, e.g., every 1 second (since the processor 224 obtains the second trigger signals from the timer 230 every 1 second) and hence continue to check connection status between the trailer 110 and the vehicle 105 every 1 second. Based on the trailer light OFF-state diagnostics, the processor 224 may transmit, via the transceiver 228, a notification to the vehicle HMI 204 and/or the user device when the processor 224 determines that the electrical connection may be interrupted or broken at any time, as described above. In this way, the processor 224 assists the vehicle operator by indicating an interrupted or broken electrical connection between the vehicle 105 and the trailer 110 in a timely manner.

In further aspects, the processor 224 may obtain inputs/readings from the battery switched resistor circuit 218 to check for short to battery (e.g., the vehicle battery 206 and/or one or more additional batteries described above) on the output. In some aspects, the processor 224 may check for short to battery before the processor 224 causes the constant current source 214 to supply the first current to the trailer lights 208. The battery switched resistor circuit 218 may also be used to discharge any capacitors that may be included in the circuitry of the trailer lights 208. The system 200 may further include a short-to-ground circuit 304 that may be used by the processor 224 to determine/decipher short to ground.

Although the description above describes an aspect where the system 200 detects trailer light connection status, in some aspects, the system 115 may also be used to detect operational status of the vehicle lights. The description above should not be construed as limiting the present disclosure scope to only detecting trailer lights.

Further, the constant current source 214 may be implemented or arranged in the system 200 in a plurality of different configurations, so as to eliminate very large resistors in the circuit that may be prone to leakage.

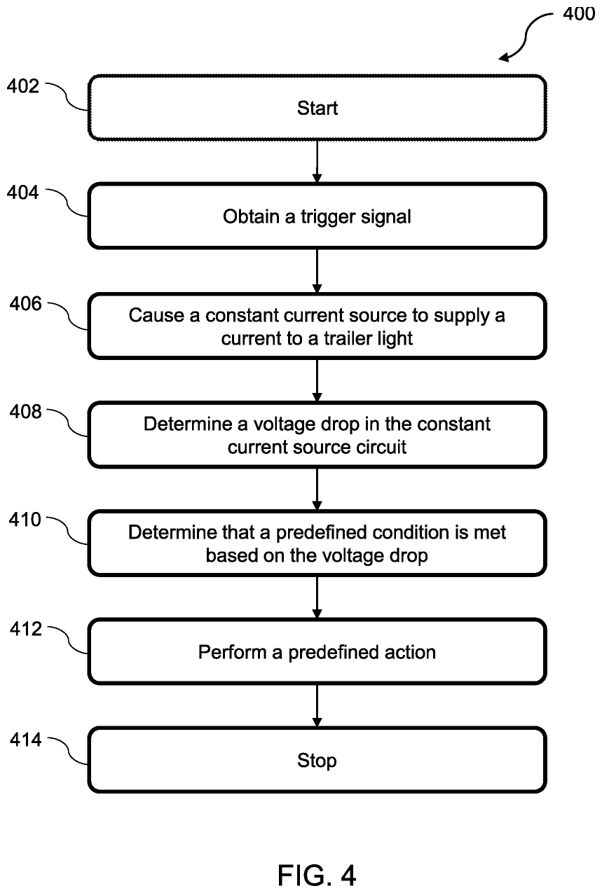

FIG. 4 depicts a flow diagram of an example trailer light management method 400 in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

Referring to FIG. 4, at step 402, the method 400 may commence. At step 404, the method 400 may include obtaining, by the processor 224, the first trigger signal. At step 406, the method 400 may include causing, by the processor 224, the constant current source 214 to supply the first current to the trailer lights 208 responsive to obtaining the first trigger signal. At step 408. the method 400 may include determining, by the processor 224, the voltage drop across the circuitry associated with the constant current source 214 responsive to supplying the first current.

At step 410, the method 400 may include determining, by the processor 224, that the predefined condition may be met based on the voltage drop. In an exemplary aspect, as described above, the processor 224 may determine that the predefined condition may be met when the voltage measured at the output of the constant current source 214 may be equivalent to the supply voltage. At step 412, the method 400 may include performing, by the processor 224, a predefined action responsive to determining that the predefined condition may be met. In an exemplary aspect, as described above, the processor 224 may transmit a notification to the vehicle HMI 204 and/or the user device when the voltage measured at the output of the constant current source 214 may be equivalent to the supply voltage. The notification may provide an indication to the vehicle operator that the trailer 110 may not be optimally coupled (e.g., electrically coupled) with the vehicle 105.

At step 414, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added. or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A trailer light management system comprising:
a constant current source circuit configured to supply a first current to a trailer light; and
a processor communicatively coupled with the constant current source circuit, wherein the processor is configured to:
obtain a first trigger signal;
cause the constant current source circuit to supply the first current to the trailer light responsive to obtaining the first trigger signal;
determine a voltage drop in the constant current source circuit responsive to supplying the first current, wherein the voltage drop is a difference between a supply voltage to the constant current source circuit and a voltage at an output of the constant current source circuit;
determine that a predefined condition is met based on the voltage drop; and
perform a predefined action responsive to determining that the predefined condition is met.

2. The trailer light management system of claim 1, wherein the processor is configured to obtain the first trigger signal when the trailer light is switched OFF.

3. The trailer light management system of claim 2 further comprising a timer, wherein the processor is configured to obtain the first trigger signal from the timer.

4. The trailer light management system of claim 1, wherein the constant current source circuit is configured to supply the first current to the trailer light as a pulse of constant current for a predefined time duration.

5. The trailer light management system of claim 1, wherein when the first current is less than a predefined current threshold, the trailer light does not illuminate responsive to receiving the first current.

6. The trailer light management system of claim 1, wherein the predefined condition is met when the voltage measured at the output of the constant current source circuit is equivalent to the supply voltage.

7. The trailer light management system of claim 6, wherein the predefined action comprises transmitting a notification to a vehicle Human-Machine Interface (HMI) or a user device, and wherein the notification indicates that the trailer light is not coupled with the constant current source circuit.

8. The trailer light management system of claim 1, wherein the predefined condition is met when the voltage measured at the output of the constant current source circuit is less than the supply voltage.

9. The trailer light management system of claim 8, wherein the predefined action comprises determining a trailer light type based on the voltage drop.

10. The trailer light management system of claim 8 further comprising a driver circuit configured to supply a second current to the trailer light, wherein the second current is greater than the first current, and wherein the trailer light illuminates responsive to receiving the second current.

11. The trailer light management system of claim 10, wherein the predefined action comprises causing the driver circuit to supply the second current to the trailer light.

12. The trailer light management system of claim 11, wherein the processor is further configured to determine a trailer light type based on the second current.

13. The trailer light management system of claim 12 further comprising a vehicle battery configured to provide power to the driver circuit.

14. The trailer light management system of claim 13 further comprising a voltage controller configured to obtain power from the vehicle battery, wherein the voltage controller is configured to supply a predefined controlled voltage to the constant current source circuit.

15. The trailer light management system of claim 1 further comprising a diode, wherein the constant current source circuit is configured to supply the first current to the trailer light via the diode.

16. The trailer light management system of claim 1 further comprising a voltage sensor configured to compare the supply voltage with the voltage at the output of the constant current source circuit, and wherein the processor is further configured to:
obtain inputs from the voltage sensor; and
determine the voltage drop in the constant current source circuit based on the inputs.

17. A trailer light management method comprising:
obtaining, by a processor, a trigger signal;
causing, by the processor, a constant current source circuit to supply a current to a trailer light responsive to obtaining the trigger signal;
determining, by the processor, a voltage drop in the constant current source circuit responsive to supplying the current, wherein the voltage drop is a difference between a supply voltage to the constant current source circuit and a voltage at an output of the constant current source circuit;
determining, by the processor, that a predefined condition is met based on the voltage drop; and
performing, by the processor, a predefined action responsive to determining that the predefined condition is met.

18. The trailer light management method of claim 17, wherein obtaining the trigger signal comprises obtaining the trigger signal when the trailer light is switched OFF.

19. The trailer light management method of claim 17, wherein the constant current source circuit supplies the current to the trailer light as a pulse of constant current for a predefined time duration.

20. A non-transitory computer-readable medium storing computer-executable instructions which when executed by one or more processors result in performing operations comprising:
obtain a trigger signal;
cause a constant current source circuit to supply a current to a trailer light responsive to obtaining the trigger signal;
determine a voltage drop in the constant current source circuit responsive to supplying the current, wherein the voltage drop is a difference between a supply voltage to the constant current source circuit and a voltage at an output of the constant current source circuit;
determine that a predefined condition is met based on the voltage drop; and
perform a predefined action responsive to determining that the predefined condition is met.
